(19) United States
(12) Patent Application Publication
(10) Pub. No.: US 2010/0169095 A1
(43) Pub. Date: Jul. 1, 2010

(54) DATA PROCESSING APPARATUS, DATA PROCESSING METHOD, AND PROGRAM

(76) Inventor: Yasuharu ASANO, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/647,315

(22) Filed: Dec. 24, 2009

(30) Foreign Application Priority Data
Dec. 26, 2008 (JP) P2008-332133

(51) Int. Cl. G10L 15/18; H04N 5/445

(52) U.S. Cl. 704/251; 725/53; 704/E15.018

(57) ABSTRACT

A data processing apparatus includes a speech recognition unit configured to perform continuous speech recognition on speech data, a related word acquiring unit configured to acquire a word related to at least one word obtained through the continuous speech recognition as a related word that is related to content corresponding to content data including the speech data, and a speech retrieval unit configured to retrieve an utterance of the related word from the speech data so as to acquire the related word whose utterance has been retrieved as metadata for the content.

### BACKGROUND OF THE INVENTION

1. Field of the Invention

The present invention relates to a data processing apparatus, a data processing method, and a program. More particularly, the present invention relates to a data processing apparatus, a data processing method, and a program configured to facilitate acquisition of metadata for speech or image content, for example.

2. Description of the Related Art

In order to recommend desired content, such as content of interest to a user, from among a variety of content of television broadcast programs, for example, it is necessary to retrieve the desired content. For enabling the content retrieval, it is necessary to assign metadata to the content in advance.

As a way of assigning metadata to content, it has been considered to use a speech recognition technique.

Specifically, in the case where content includes speech, like a television broadcast program, and content data of the content includes speech data, then the speech data may be subjected to speech recognition, and the word obtained through the speech recognition may be used as metadata for the content.

However, even in the case where speech recognition is performed using a large vocabulary continuous speech recognition system which can recognize a large number of words, the words that can be obtained through the speech recognition are limited to those registered in advance in a word dictionary that the system uses for the speech recognition.

Therefore, it is difficult to obtain a word (hereinafter, referred to as an “unregistered word”) which has not been registered in the word dictionary, for use as metadata.

The unregistered words may include a newly appeared word (hereinafter, referred to as a “new word”) which has recently become of a frequent use, and a proper name such as the name of a not-so-famous place.

In order to obtain such new words and proper names as metadata, it is necessary to register those unregistered words in a word dictionary as recognition target words.

Registering the unregistered words, including the new words and proper names, in the word dictionary so as to increase the number of recognition target words, however, leads to an increase in time necessary for performing the speech recognition process as well as degradation in accuracy of the speech recognition.

In order to improve the recognition rate of a word in a short utterance, there has been proposed a method of performing continuous speech recognition wherein a continuous speech recognition dictionary is generated from a corpus to be recognized, and a complementary recognition dictionary for improving recognition of unregistered words is also generated in consideration of the continuous speech recognition dictionary, and both the continuous speech recognition dictionary and the complementary recognition dictionary are used to perform the continuous speech recognition (see, for example, Japanese Unexamined Patent Application No. 2008-242059).

### SUMMARY OF THE INVENTION

It may be possible to obtain metadata by using a speech retrieval technique wherein speech data is searched for an utterance of a specific word and the timing (time) of occurrence of the utterance of the specific word in the speech data is detected.

Specifically, in the speech retrieval, speech data may be searched for an utterance of a word which can be metadata for content, and the word whose utterance is included in the speech data may be obtained as the metadata for the content.

There however are a huge number of words that are desired to be obtained as metadata for content. If such a large number of words are to be retrieved, the speech retrieval will take a considerable amount of time, rendering acquisition of the metadata difficult.

In view of the foregoing, a technique which can facilitate acquisition of metadata is desired.

According to an embodiment of the present invention, there is provided a data processing apparatus which includes: a speech recognition unit configured to perform continuous speech recognition on speech data; a related word acquiring unit configured to acquire a word related to at least one word obtained through the continuous speech recognition as a related word that is related to content corresponding to content data including the speech data; and a speech retrieval unit configured to retrieve an utterance of the related word from the speech data so as to acquire the related word whose utterance has been retrieved as metadata for the content. According to another embodiment of the present invention, there is provided a program for causing a computer to function as the data processing apparatus.

According to yet another embodiment of the present invention, there is provided a data processing method which includes the steps of: performing continuous speech recognition on speech data; acquiring a word related to at least one word obtained through the continuous speech recognition as a related word that is related to content corresponding to content data including the speech data; and retrieving an utterance of the related word from the speech data so as to acquire the related word whose utterance has been retrieved as metadata for the content; the steps being performed by a data processing apparatus.

In the above embodiments of the present invention, speech data is subjected to continuous speech recognition, and any word related to at least one word obtained through the continuous speech recognition is acquired as a related word that is related to content corresponding to content data including the speech data. Then, the speech data is searched for an utterance of the related word, and the related word whose utterance has been retrieved is obtained as metadata for the content.

It is noted that the data processing apparatus may be an independent apparatus, or may be an internal block included in an apparatus.

Further, the program may be provided as a program transmitted through a transmission medium or as a program recorded on a recording medium.

According to the above embodiments of the present invention, it is readily possible to acquire metadata.

### BRIEF DESCRIPTION OF THE DRAWINGS

FIG. 1 is a block diagram showing a configuration example of a first embodiment of a recorder to which the present invention has been applied;

FIG. 2 is a flowchart illustrating a metadata collecting process;

FIG. 3 is a flowchart illustrating a reproduction process;

FIG. 4 is a block diagram showing a configuration example of a second embodiment of the recorder to which the present invention has been applied;

FIG. 5 illustrates a topic estimating method using a vector space method;

FIGS. 6A and 6B illustrate “tf” and “idf”;

FIG. 7 is another flowchart illustrating the metadata collecting process; and

FIG. 8 is a block diagram showing a configuration example of an embodiment of a computer to which the present invention has been applied.

### DESCRIPTION OF THE PREFERRED EMBODIMENTS

### First Embodiment

### Configuration Example of First Embodiment of Recorder to which the Present Invention has been Applied

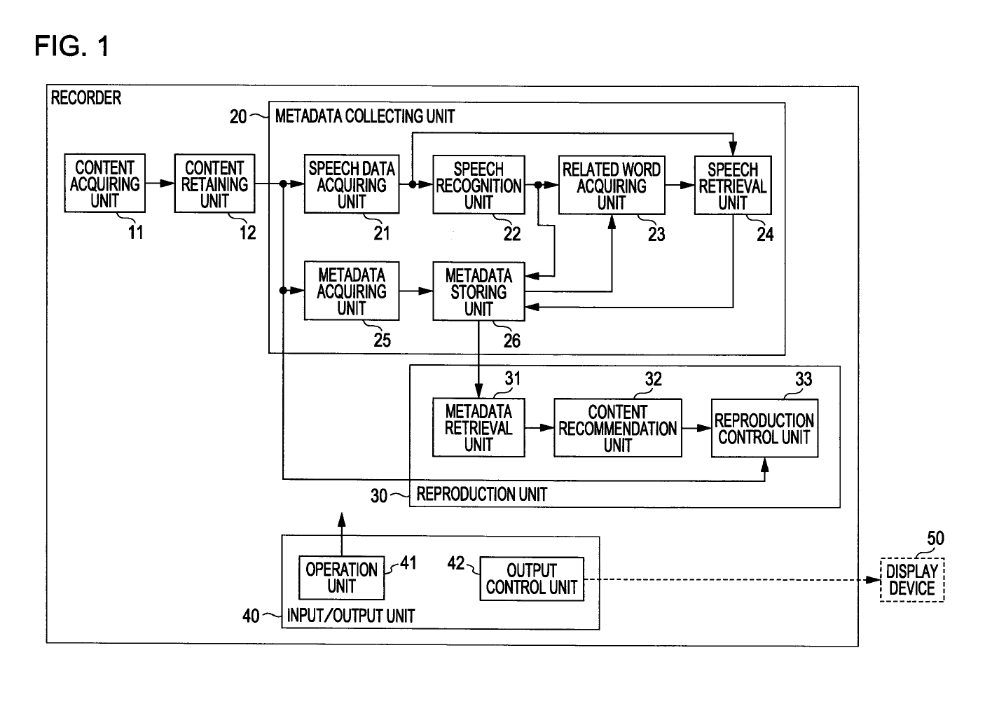

FIG. 1 is a block diagram showing a configuration example of a first embodiment of a recorder to which the present invention has been applied.

Referring to FIG. 1, the recorder is a hard disk (HD) recorder, for example, and includes: a content acquiring unit 11, a content retaining unit 12, a metadata collecting unit 20, a reproduction unit 30, and an input/output unit 40.

The content acquiring unit 11 acquires content data of image and speech content constituting a television broadcast program, for example, and supplies the content data to the content retaining unit 12.

In the case where the content data is accompanied with metadata for the content corresponding to that content data, the content acquiring unit 11 also acquires and supplies the metadata to the content retaining unit 12.

Specifically, the content acquiring unit 11 may be a tuner which receives broadcast data in television broadcasts such as digital television broadcasts. The content acquiring unit 11 receives the broadcast data transmitted (broadcast) from a broadcast station (not shown), and supplies the acquired data to the content retaining unit 12.

Here, the broadcast data includes content data which is data for content or a program. The broadcast data may also include metadata for the program (i.e., metadata assigned to the program (content)), such as electronic program guide (EPG) data, as appropriate.

Although content data as the data for a program may include image data of the program and speech data accompanying the image data, the content data to be acquired by the content acquiring unit 11 has only to include at least the speech data, like music data.

It is noted that the content acquiring unit 11 may be constituted by a communication interface (I/F) which carries out communications via a network such as a local area network (LAN) or the Internet. In this case, the content acquiring unit 11 receives and acquires the content data and metadata transmitted from a server on the network.

The content retaining unit 12 may be configured with a large-capacity recording (storage) medium, such as a hard disk (HD). The content retaining unit 12 records (or stores or retains) the content data supplied from the content acquiring unit 11, as necessary.

In the case where the metadata for the content (program) such as the EPG data is supplied from the content acquiring unit 11 to the content retaining unit 12, the content retaining unit 12 records the metadata as well.

It is noted that recording of the content data on the content retaining unit 12 corresponds to “recording” (including programmed recording and so-called “automatic recording”).

The metadata collecting unit 20 functions as a data processing apparatus which collects metadata for the content whose content data has been recorded in the content retaining unit 12.

Specifically, the metadata collecting unit 20 is constituted by a speech data acquiring unit 21, a speech recognition unit 22, a related word acquiring unit 23, a speech retrieval unit 24, a metadata acquiring unit 25, and a metadata storing unit 26.

The speech data acquiring unit 21 acquires speech data included in the content data for content of interest that is being focused on among a plurality of content items whose content data have been recorded in the content retaining unit 12, by reading the speech data from the content retaining unit 12. The speech data acquiring unit 21 supplies the acquired speech data to the speech recognition unit 22 and the speech retrieval unit 24.

The speech recognition unit 22 may have a function of carrying out large vocabulary continuous speech recognition in which a large number of words can be recognized. The speech recognition unit 22 performs (continuous) speech recognition on the speech data supplied from the speech data acquiring unit 21.

Further, the speech recognition unit 22 supplies at least one word (string) obtained as a result of the speech recognition to the related word acquiring unit 23 and the metadata storing unit 26.

Here, the speech recognition unit 22 has a word dictionary incorporated therein, and performs speech recognition using the words registered in the word dictionary as the recognition target words. Thus, the words obtained through the speech recognition by the speech recognition unit 22 are those registered in the word dictionary.

The related word acquiring unit 23 acquires any word related to the word obtained through the speech recognition and supplied from the speech recognition unit 22, as a related word that is related to the content of interest. The related word acquiring unit 23 supplies the acquired related word to the speech retrieval unit 24.

For example, the related word acquiring unit 23 may use a thesaurus, so as to acquire a word whose meaning is close to that of the word obtained through the speech recognition, as the related word.

Alternatively, the related word acquiring unit 23 may use data about word co-occurrence probability, so as to acquire a word which is likely to occur together with the word obtained through the speech recognition, i.e., a word whose probability of co-occurrence with the word obtained through the speech recognition is not less than a predetermined threshold value, as the related word.

The thesaurus or the co-occurrence probability data may be stored in the related word acquiring unit 23 as static data.

Further, the related word acquiring unit 23 may acquire a related word (or information for acquiring the related word) from a server on the network.

Specifically, the related word acquiring unit 23 may perform crawling to collect information from a server on the network, and use the collected information to update the thesaurus or the co-occurrence probability data. Then, the related word acquiring unit 23 may use the updated thesaurus or co-occurrence probability data so as to acquire the related word.

For updating the thesaurus, a word may be added to the thesaurus, or the linkage (relation) between the words on the thesaurus may be updated. For updating the co-occurrence probability data, a word may be added to the co-occurrence probability data, or the value of the co-occurrence probability may be updated.

As described above, the related word acquiring unit 23 is able to acquire a related word from a server on the network. This allows a word not registered in the word dictionary incorporated in the speech recognition unit 22, such as a new word which has recently become of a frequent use or a proper name, to be acquired as the related word.

The speech retrieval unit 24 searches the speech data supplied from the speech data acquiring unit 21 for an utterance of the related word supplied from the related word acquiring unit 23. Then, the speech retrieval unit 24 acquires the related word whose utterance has been found, as metadata for the content of interest (i.e., the content corresponding to the content data which includes the speech data supplied from the speech data acquiring unit 21). The speech retrieval unit 24 supplies the acquired metadata to the metadata storing unit 26.

In the case where metadata for the content of interest is recorded in the content retaining unit 12, the metadata acquiring unit 25 acquires the metadata for the content of interest by reading it from the content retaining unit 12, and supplies the acquired metadata to the metadata storing unit 26.

The metadata storing unit 26 stores the word which has been supplied from the speech recognition unit 22 as a result of the speech recognition, as metadata for the content of interest.

The metadata storing unit 26 also stores the metadata for the content of interest which are supplied from the speech retrieval unit 24 and the metadata acquiring unit 25.

Here, of the metadata stored in the metadata storing unit 26, the word supplied from the speech recognition unit 22 as a result of the speech recognition is also referred to as “recognition result metadata”.

Further, of the metadata stored in the metadata storing unit 26, the metadata supplied from the speech retrieval unit 24 is also referred to as “retrieval result metadata”.

Still further, of the metadata stored in the metadata storing unit 26, the metadata supplied from the metadata acquiring unit 25, i.e., the metadata assigned (in advance) to the content of interest is also referred to as “pre-assigned metadata”.

It is noted that, in the metadata collecting unit 20, the metadata storing unit 26 has been configured to store all the words supplied as a result of the speech recognition from the speech recognition unit 22, as the metadata for the content of interest. Alternatively, the metadata storing unit 26 may be configured to store only the necessary words as the metadata for the content of interest.

Specifically, each word registered in the word dictionary incorporated in the speech recognition unit 22 may be applied with a flag to indicate whether to store the word as metadata, for example. In this case, the metadata storing unit 26 may store, as the metadata for the content of interest, only the word applied with the flag indicating that the word should be stored as metadata, among the words supplied as a result of the speech recognition from the speech recognition unit 22.

Further, in the metadata collecting unit 20, the related word acquiring unit 23 may be configured to acquire, as the related words, not only the words related to the words supplied from the speech recognition unit 22 as a result of the speech recognition, but also the words related to the words stored as the pre-assigned metadata in the metadata storing unit 26.

Specifically, for example in the case where the pre-assigned metadata stored in the metadata storing unit 26 include a proper name, the related word acquiring unit 23 may acquire a proper name or the like related to that proper name, as a related word.

More specifically, for example assume that the content of interest is a TV drama program and that the pre-assigned metadata includes the name of a performer appearing in the TV drama program that is the content of interest. In this case, the names of performers who have played with the performer before and the titles of other TV programs in which the performer had played a role may be acquired as the related words. The names of the performers and the titles of the TV programs as the related words may be acquired, e.g., from a web server which provides information of the TV programs.

Furthermore, in the metadata collecting unit 20, the related word acquiring unit 23 may be configured to acquire, from among the words related to the words obtained through speech recognition by the speech recognition unit 22, only the words other than the words that should be recognized in the speech recognition process, as the related words.

Specifically, in the case where a certain word A is a related word and an utterance of the related word A has been retrieved from speech data by the speech retrieval unit 24, the related word A is stored in the metadata storing unit 26 as metadata for the content of interest.

Meanwhile, if the word A is a recognition target word, i.e., if the word A has been registered in the word dictionary incorporated in the speech recognition unit 22, the word A may be stored as the recognition result metadata in the metadata storing unit 26 provided that the speech recognition had been performed successfully in the speech recognition unit 22.

Thus, in this case, the speech retrieval unit 24 does not have to retrieve the word A from the speech data as the related word, because the word A being the recognition target word would be stored in the metadata storing unit 26 as the recognition result metadata.

The related word acquiring unit 23 is configured to acquire, as the related words, only the words other than the words that should be recognized by the speech recognition unit 22. That is, the related word acquiring unit 23 is configured not to acquire the target words of the speech recognition as the related words. This can reduce the number of related words which become target words of speech retrieval performed by the speech retrieval unit 24, and accordingly, speedy processing of speech retrieval by the speech retrieval unit 24 is ensured.

It is noted that, in the metadata collecting unit 20, the metadata storing unit 26 is configured to store the metadata for the content of interest in association with content data for the content of interest that has been recorded in the content retaining unit 12. For example, the metadata storing unit 26 may store the metadata for the content of interest, together with identification information for identifying the content of interest.

Further, when an utterance of a related word has been found in the speech data for the content of interest, the metadata storing unit 26 may store timing information indicating the timing of utterance of that related word in the speech data, in association with the metadata that is the related word, as necessary.

That is, in this case, the speech retrieval unit 24 acquires the related word whose utterance has been found in the speech data as the metadata, and also detects the timing of utterance of the related word in the speech data. The speech retrieval unit 24 then supplies the related word as the metadata together with the timing information indicating the timing of utterance of the related word, to the metadata storing unit 26.

In response, the metadata storing unit 26 stores the related word as the metadata and its timing information, supplied from the speech retrieval unit 24, in association with each other.

Here, for the timing information indicating the timing of utterance of the related word in the speech data, the time (such as a time code) with respect to the beginning of the speech data (i.e., the beginning of the content corresponding to the content data including the speech data) may be adopted.

The reproduction unit 30 functions as a data processing apparatus which reproduces content data recorded in the content retaining unit 12.

Specifically, the reproduction unit 30 is constituted by a metadata retrieval unit 31, a content recommendation unit 32, and a reproduction control unit 33.

In the case where a user operates an operation unit 41, which will be described later, to input a keyword for retrieval of content, the metadata retrieval unit 31 searches for metadata matching or similar to the input keyword. The keyword may be the name of a performer the user is interested in, for example.

Specifically, the metadata retrieval unit 31 retrieves, from the metadata stored in the metadata storing unit 26, metadata matching or similar to the keyword that has been input through the user operation of the operation unit 41.

Further, the metadata retrieval unit 31 provides the content recommendation unit 32 with identification information for identifying the content corresponding to the content data that is associated with the metadata (hereinafter, also referred to as “matching metadata”) matching or similar to the keyword in the metadata storing unit 26.

The content recommendation unit 32 regards the content identified by the identification information received from the metadata retrieval unit 31 as recommended content to be recommended to a viewer/listener, and generates a list of titles of the recommended content. The content recommendation unit 32 then causes the list of titles of the recommended content to be displayed on a display device 50 such as a television receiver set (TV set) via an output control unit 42, which will be described later, in order to recommend viewing/listening of the recommended content.

Further, when a user operates the operation unit 41 to select a title of the recommended content to be reproduced from the list of the titles displayed on the display device 50, the content recommendation unit 32 transmits to the reproduction control unit 33 a designation of the recommended content of that title as content to be reproduced.

When receiving the designation of the content to be reproduced from the content recommendation unit 32, the reproduction control unit 33 reads the content data for the content to be reproduced from the content retaining unit 12, for reproduction thereof.

Specifically, the reproduction control unit 33 performs decoding and other necessary processing on the content data of the content to be reproduced, and supplies the resultant data to the display device 50 via the output control unit 42.

As a result, in the display device 50, images corresponding to the image data included in the content data of the content to be reproduced are displayed on a display screen, and the sound corresponding to the speech data included in the content data is output from a built-in speaker or the like.

The input/output unit 40 functions as an interface for performing necessary input/output operations with respect to the recorder.

Specifically, the input/output unit 40 is constituted by the operation unit 41 and the output control unit 42.

The operation unit 41 may be a keyboard (with keys and buttons) or a remote commander, which is operated by a user. The operation unit 41 supplies (inputs) signals corresponding to the user operations to various blocks as appropriate.

The output control unit 42 controls output of data (signals) to an external device such as the display device 50. Specifically, the output control unit 42 may output, e.g., a list of titles of the recommended content generated by the content recommendation unit 32, and content data of the content to be reproduced by the reproduction control unit 33, to the display device 50.

[Description of Metadata Collecting Process]

The recorder shown in FIG. 1 performs a metadata collecting process of collecting metadata for content.

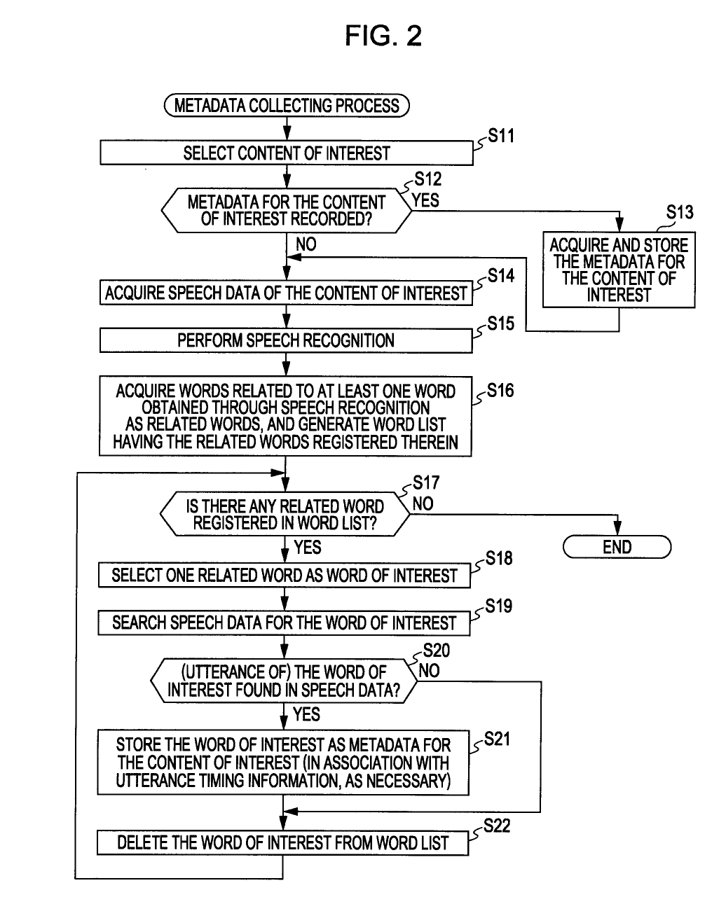

The metadata collecting process will now be described with reference to FIG. 2.

It is here assumed that content data for at least one content item has already been recorded in the content retaining unit 12.

The metadata collecting process is started at an arbitrary time. In step S11, the metadata collecting unit 20 selects, from among the content items whose content data have been recorded in the content retaining unit 12, content for which metadata is to be collected (and the content for which metadata has not been collected yet) as content of interest to be focused on.

The process proceeds from step S11 to step S12, where the metadata acquiring unit 25 determines whether metadata for the content of interest has been recorded in the content retaining unit 12.

If it is determined in step S12 that the metadata for the content of interest is recorded in the content retaining unit 12, the process proceeds to step S13, where the metadata acquiring unit 25 acquires the metadata for the content of interest from the content retaining unit 12. Further, the metadata acquiring unit 25 supplies the metadata for the content of interest to the metadata storing unit 26 as pre-assigned metadata, to cause the metadata storing unit 26 to store the metadata in association with the content data for the content of interest. The process then proceeds from step S13 to step S14.

If it is determined in step S12 that the metadata for the content of interest is not recorded in the content retaining unit 12, the process proceeds to step S14, with step S13 being skipped.

In step S14, the speech data acquiring unit 21 acquires from the content retaining unit 12 speech data (data of speech waveform) included in the content data for the content of interest, and supplies the acquired data to the speech recognition unit 22 and the speech retrieval unit 24. The process then proceeds to step S15.

In step S15, the speech recognition unit 22 performs speech recognition on the speech data received from the speech data acquiring unit 21, and supplies at least one word (string) obtained as a result of the speech recognition to the related word acquiring unit 23 and the metadata storing unit 26. The process then proceeds to step S16.

Here, in receipt of the word from the speech recognition unit 22 as a result of the speech recognition, the metadata storing unit 26 stores the received word as recognition result metadata, in association with the content data for the content of interest, as necessary.

Further, for performing the speech recognition, the speech recognition unit 22 uses, e.g., a hidden Markov model (HMM) as an acoustic model, and an N-gram or other statistical language model as a language model.

In step S16, the related word acquiring unit 23 acquires any word related to the word supplied from the speech recognition unit 22 as a result of the speech recognition, as a related word.

The related words may include, not only the word which is related to the word obtained through the speech recognition, but also a word which is related to the word included in the pre-assigned metadata for the content of interest stored in the metadata storing unit 26 in step S13. Further, for example in the case where the user profile has been registered in the recorder shown in FIG. 1 or the like, the related word acquiring unit 23 may estimate an object the user may be interested in from that profile, and acquire a word representing the object or related to the object. In this case, the related word acquiring unit 23 can regard the word related to the object the user is interested in, as the related word.

Once acquiring the related words, the related word acquiring unit 23 generates a word list having the related words registered therein, and supplies the word list to the speech retrieval unit 24. The process then proceeds from step S16 to step S17.

In step S17, the speech retrieval unit 24 determines whether the word list supplied from the related word acquiring unit 23 has any related word registered therein.

If it is determined in step S17 that at least one related word is registered in the word list, the process proceeds to step S18, where the speech retrieval unit 24 selects one of the related words registered in the word list as a word of interest to be focused on. The process then proceeds to step S19.

In step S19, the speech retrieval unit 24 performs speech retrieval to retrieve an utterance of the word of interest from the speech data for the content of interest supplied from the speech data acquiring unit 21, and the process proceeds to step S20.

Here, the speech retrieval of the utterance of the word of interest from the speech data may be performed using so-called “keyword spotting”, or may be performed in the following manner. For the speech data supplied from the speech data acquiring unit 21 to the speech retrieval unit 24, indices representing phonemes and positions of the phonemes in the speech data may be generated, and a sequence of phonemes constituting the word of interest may be retrieved from the indices.

In step S20, the speech retrieval unit 24 determines whether an utterance of the word of interest (i.e., speech data of utterance of the word of interest) is included in the speech data for the content of interest, on the basis of a result of the speech retrieval performed in step S19.

If it is determined in step S20 that the speech data for the content of interest includes the utterance of the word of interest, the process proceeds to step S21.

In step S21, the speech retrieval unit 24 supplies the word of interest as the retrieval result metadata to the metadata storing unit 26, so as to cause the metadata storing unit 26 to store the metadata in association with the content data for the content of interest. The process then proceeds to step S22.

Here, in the speech retrieval unit 24, the timing of utterance of the word of interest in the speech data may be detected upon the speech retrieval of the word of interest, and the timing information indicating that timing may be supplied to the metadata storing unit 26 together with the retrieval result metadata which is the word of interest.

In this case, the metadata storing unit 26 stores the retrieval result metadata and the timing information, supplied from the speech retrieval unit 24, in association with the content data for the content of interest.

On the other hand, if it is determined in step S20 that the speech data for the content of interest does not include an utterance of the word of interest, the process proceeds to step S22, with step S21 being skipped.

In step S22, the speech retrieval unit 24 deletes the word of interest from the word list, and the process returns to step S17 to repeat the similar process.

Then, if it is determined in step S17 that there is no related word registered in the word list, the metadata collecting process is finished.

As described above, in the metadata collecting process, speech recognition (continuous speech recognition) is performed on the speech data for the content of interest in the speech recognition unit 22, and in the related word acquiring unit 23, any word related to at least one word obtained through the speech recognition is acquired as a related word. Then, in the speech retrieval unit 24, the speech data for the content of interest is searched for an utterance of the related word, and the related word whose utterance has been found is acquired as metadata for the content of interest.

Accordingly, in the speech retrieval unit 24, the words related to at least one word obtained through the speech recognition are regarded as the related words and used as target words of retrieval (speech retrieval). As the target words of speech retrieval are restricted to the related words as described above, the speech retrieval process can be performed in a shorter period of time than in the case where the speech retrieval is carried out for all the words wished to be acquired as the metadata for the content.

As a result, the metadata for the content can be acquired efficiently and with ease. Moreover, even the word that is not a target word of speech recognition can be acquired as the metadata.

Furthermore, for example in the case where the related word acquiring unit 23 is configured to acquire the related words from a server on a network such as the Internet, newly appeared words (new words) and proper names can be acquired as the related words from the web pages on the server where the information stored is updated in a daily basis. Accordingly, it is readily possible to acquire such new words and proper names as the metadata.

[Description of Reproduction Process]

The recorder shown in FIG. 1 performs, besides the metadata collecting process, a reproduction process in which content is recommended and reproduced by using the metadata collected in the metadata collecting process.

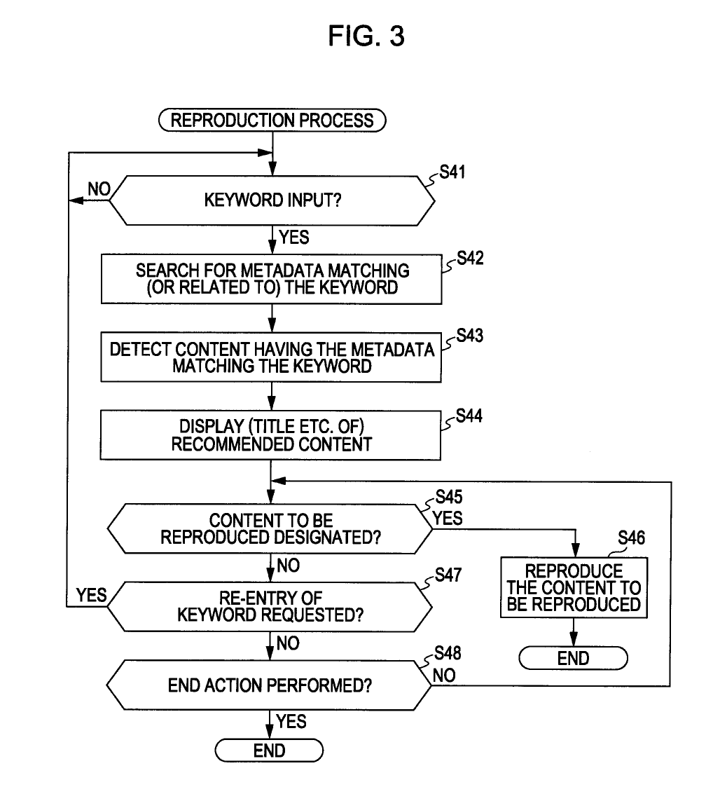

The reproduction process will now be described with reference to FIG. 3.

It is here assumed that the metadata collecting process has been performed, and that the metadata storing unit 26 stores metadata for at least one content item whose content data is recorded in the content retaining unit 12.

In the reproduction process, firstly in step S41, the metadata retrieval unit 31 determines whether a keyword has been input.

If it is determined in step S41 that a keyword has not been input, the process returns to step S41.

If it is determined in step S41 that a keyword has been input, i.e., when a user has input a keyword by operating the operation unit 41, the process proceeds to step S42.

In this example, the keyword is input through the user operation of the operation unit 41. Alternatively, for example in the case where the user profile has been registered in the recorder shown in FIG. 1 or the like, the profile may be used to input a keyword. That is, an object the user may be interested in can be estimated from the user profile and a word representing the object or the like may be input as a keyword.

In step S42, the metadata retrieval unit 31 searches the metadata stored in the metadata storing unit 26 for metadata (matching metadata) matching or similar to the keyword input through the user operation of the operation unit 41. The process then proceeds to step S43.

In step S43, the metadata retrieval unit 31 detects the content data that is associated with the matching metadata matching or similar to the keyword obtained through the retrieval in step S42, and supplies identification information for identifying the content corresponding to the detected content data to the content recommendation unit 32.

The process then proceeds from step S43 to step S44, where the content recommendation unit 32 recommends the content identified by the identification information received from the metadata retrieval unit 31 as recommended content, and the process proceeds to step S45.

Specifically, the content recommendation unit 32 generates a list of titles of the recommended content, and supplies the list to the output control unit 42.

In response, the output control unit 42 supplies the list of the titles received from the content recommendation unit 32 to the display device 50 for display.

In step S45, the reproduction control unit 33 determines whether content to be reproduced has been designated.

If it is determined in step S45 that the content to be reproduced has been designated, i.e., in the case where the user had operated the operation unit 41 to select from the list of the titles displayed on the display device 50 a title of the recommended content to be reproduced, and the content recommendation unit 32, in response to the user operation of the operation unit 41, has instructed the reproduction control unit 33 to reproduce the recommended content of the title selected by the user, then the process proceeds to step S46. In step S46, the reproduction control unit 33 reproduces the content to be reproduced, by reading the content data for the content from the content retaining unit 12.

Specifically, the reproduction control unit 33 performs decoding and other necessary processing on the content data for the content to be reproduced, and supplies the resultant data to the output control unit 42. The output control unit 42 receives the content data from the reproduction control unit 33 and supplies the data to the display device 50. Accordingly, in the display device 50, the images corresponding to the image data included in the content data for the content to be reproduced are displayed, and at the same time, the sound corresponding to the speech data included in the content data is output.

Thereafter, upon completion of reproduction of all the content data for the content to be reproduced, for example, the reproduction process is finished.

On the other hand, if it is determined in step S45 that the content to be reproduced has not been designated, the process proceeds to step S47, where the metadata retrieval unit 31 determines whether the operation unit 41 has been operated so as to request re-entry of a keyword.

If it is determined in step S47 that the operation unit 41 has been operated so as to request re-entry of a keyword, the process returns to step S41, and the similar process is repeated.

If it is determined in step S47 that the operation unit 41 has not been operated so as to request re-entry of a keyword, the process proceeds to step S48, where the metadata retrieval unit 31 determines whether the operation unit 41 has been operated so as to terminate the reproduction process.

If it is determined in step S48 that the operation unit 41 has not been operated so as to terminate the reproduction process, the process returns to step S45, and the similar process is repeated.

If it is determined in step S48 that the operation unit 41 has been operated so as to terminate the reproduction process, the reproduction process is terminated.

As described above, according to the metadata collecting process, words such as new words and proper names which are not the target words of the speech recognition can be acquired as the metadata. Further, according to the reproduction process performed using such metadata, it is possible to properly (accurately) retrieve, recommend, and reproduce the content that the user is interested in.

### Second Embodiment

### Configuration Example of Second Embodiment of Recorder To which the Present Invention has been Applied

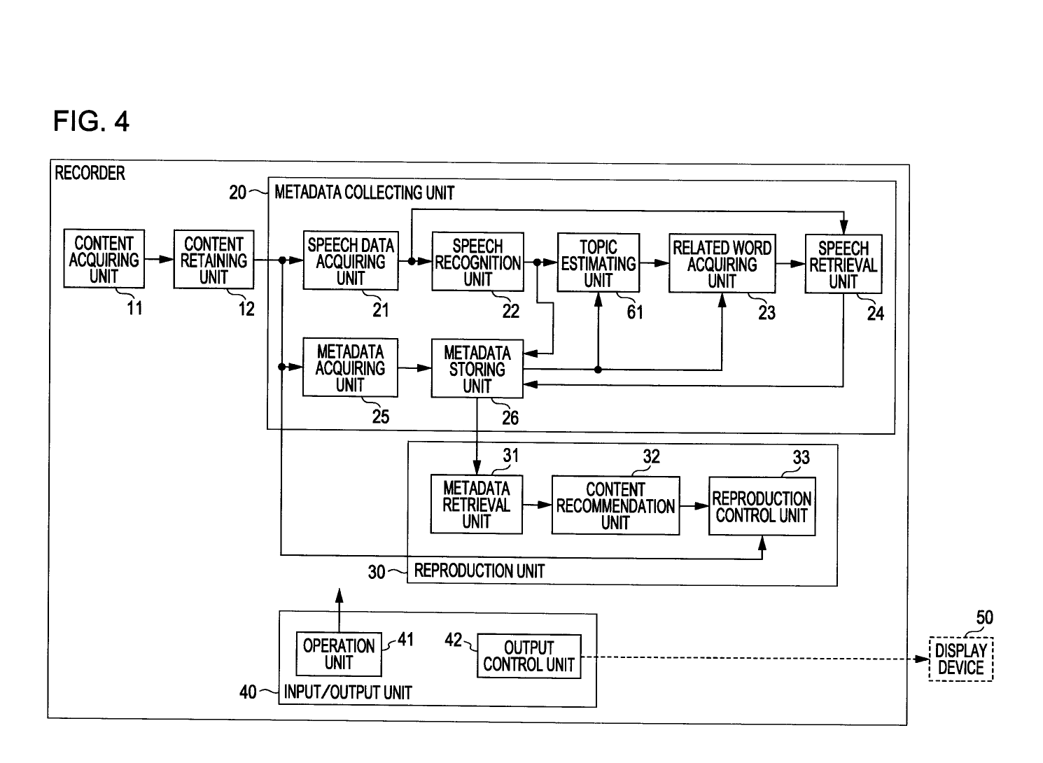

FIG. 4 is a block diagram showing a configuration example of a second embodiment of the recorder to which the present invention has been applied.

In FIG. 4, the parts corresponding to those in FIG. 1 are denoted by the similar reference characters, and description thereof will not be repeated as appropriate.

The recorder shown in FIG. 4 is identical in terms of configuration to the recorder shown in FIG. 1 except that a topic estimating unit 61 has been added to the metadata collecting unit 20.

The topic estimating unit 61 receives at least one word obtained as a result of speech recognition from the speech recognition unit 22.

The topic estimating unit 61, on the basis of the at least one word supplied from the speech recognition unit 22 as a result of the speech recognition, estimates a topic of the substance of the speech corresponding to the speech data for the content of interest. The topic estimating unit 61 supplies the estimated topic to the related word acquiring unit 23 as a topic of the content of interest.

Specifically, the topic estimating unit 61 estimates a topic of a sentence (text) similar to the at least one word (string) obtained through the speech recognition, as the topic of the content of interest.

In this case, the related word acquiring unit 23 acquires any word related to the topic of the content of interest supplied from the topic estimating unit 61, as the related word.

The topic estimating unit 61 may estimate the topic of the content of interest on the basis of, not only the words supplied from the speech recognition unit 22 as a result of the speech recognition, but also the words included in the pre-assigned metadata stored in the metadata storing unit 26, which include, e.g., the proper names such as the name of a performer and program title included in the EPG data and the words constituting a text introducing the summary of the program.

Furthermore, in FIG. 4, the related words acquired by the related word acquiring unit 23 are not limited to the words related to the topic of the content of interest. The related word acquiring unit 23 may also acquire the words related to the words included in the pre-assigned metadata stored in the metadata storing unit 26 as the related words, as in the case of FIG. 1.

It is noted that the related word acquiring unit 23 may generate lists of words related to various topics as topic related word lists in advance. In this case, the related word acquiring unit 23 may acquire the words registered in the topic related word list corresponding to the topic of the content of interest, as the related words.

The topic related word lists may be stored in the related word acquiring unit 23 as static data.

Further, the related word acquiring unit 23 may acquire the related words (and information for obtaining the related words) from a server on the network.

Specifically, the related word acquiring unit 23 may perform crawling to collect information such as texts (sentences) constituting web pages from the network, and use the information to update a topic related word list. Then, the related word acquiring unit 23 may use the updated topic related word list to obtain the related words.

Here, in updating the topic related word list, the words registered in the topic related word list may be updated (modified) to the words whose number of times of occurrence in the sentences of the topic corresponding to the topic related word list, among the sentences collected from the network by crawling, is not less than a predetermined threshold value, or the words ranked higher in terms of the number of times of occurrence.

As described above, in the related word acquiring unit 23, the related words (registered in the topic related word list) are acquired from the server on the network. This makes it possible to acquire the words not registered in the word dictionary incorporated in the speech recognition unit 22, including the new words that have recently become of a frequent use and the proper names, as the related words.

[Description of Topic Estimating Method]

Hereinafter, a method of estimating the topic of the content of interest, performed by the topic estimating unit 61 shown in FIG. 4, will be described.

The topic may be estimated by a method using a so-called topic model, such as probabilistic latent semantic analysis (PLSA) or latent Dirichlet allocation (LDA).

Alternatively, the topic may be estimated by a method using a vector space method, in which each sentence (word string) is expressed by a vector on the basis of the words constituting the sentence, and the vectors are used to obtain a cosine distance between a sentence whose topic is to be estimated (hereinafter, also referred to as an “input sentence”) and a sentence whose topic has already been known (hereinafter, also referred to as an “example sentence”).

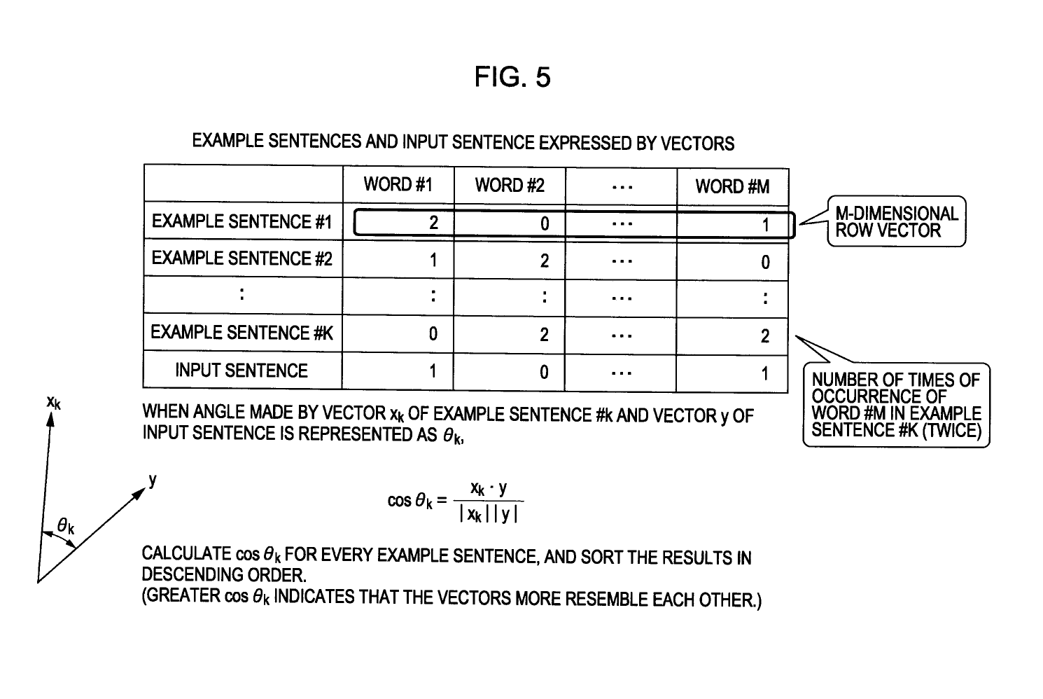

The topic estimating method using the vector space method will now be described with reference to FIG. 5.

According to the vector space method, each sentence (word string) is expressed by a vector, and as similarity between sentences or a distance therebetween, an angle (cosine distance) made by the vectors of the sentences is obtained.

More specifically, in the vector space method, database (hereinafter, also referred to as “example sentence database”) for the sentences (example sentences) whose topics have already been known is prepared.

In FIG. 5, the example sentence database stores K example sentences from #1 to #K, and of the words appearing in the K example sentences of #1 to #K, M words that are expressed differently from each other are adopted as the elements of the vectors.

In this case, as shown in FIG. 5, each example sentence stored in the example sentence database may be expressed by an M-dimensional vector having the M words #1, #2, #M as its elements.

For the element value corresponding to the word #m (m=1, 2, . . . , M) in the vector representing the example sentence, the number of times of occurrence of the word #m in that example sentence, for example, may be adopted.

An input sentence may also be expressed by an M-dimensional vector, as in the case of the example sentences.

Referring to FIG. 5, when a vector representing a certain example sentence #k (k=1, 2, . . . , K) is expressed as xₖ, a vector representing an input sentence as y, and an angle made by the vectors xₖ and y as θₖ, then the cosine cos θₖ can be obtained in accordance with the following expression (1).

cos θₖ=x_{k·y}/(|xₖ∥y|) (1)

In the expression (1), “·” represents the inner product, and “|z|” represents the norm of a vector z.

cos θₖ takes a maximum value of “1” when the vectors xₖ and y are in the same direction, while it takes a minimum value of “−1” when the vectors xₖ and y are in the opposite directions. Here, the vector y of the input sentence and the vector xₖ of the example sentence #k have their elements taking values of “0” or greater, and thus, the minimum value of cos θₖ of the vectors xₖ and y is “0”.

In the vector space method, cos θₖ is calculated for each example sentence #k as a score, and the example sentence #k providing the greatest score, for example, is obtained as the example sentence that is most similar to the input sentence.

The topic estimating unit 61 uses at least one word string obtained through speech recognition in the speech recognition unit 22 as an input sentence, and obtains an example sentence that is most similar to the input sentence. The topic estimating unit 61 then obtains a topic of the example sentence most similar to the input sentence as a result of estimation of the topic of the content of interest.

In FIG. 5, the number of times of occurrence of a word in a sentence has been adopted as a value of the element in the vector representing the input or example sentence. This number of times of occurrence of the word is called “term frequency (tf)”.

Generally, when “tf” is used as the element value in the vector, the score tends to be affected by the words whose frequencies of occurrence are high. Further, in Japanese language, the particles and auxiliary verbs tend to have high occurrence frequencies. Thus, in the case where “tf” is used as the value of the element in the vector, the obtained score would be largely affected by the particles and auxiliary verbs included in the input or example sentence.

As a way of reducing the effects of the words whose occurrence frequencies are high, “invert document frequency (idf)” or “TF-IDF” as a combination of “tf” and “idf” may be used in place of “tf” as the value of the element in the vector.

When the total number of texts (obtained by summing up the numbers of example and input sentences) is represented as “N” and the number of texts among the N texts including the word tᵢ which is the i-th element in the vector is represented as “dfᵢ”, then “idf” of the word tᵢ can be expressed, e.g., by the following expression (2).

idf=log₂(N/dfᵢ) (2)

According to the expression (2), the word which occurs frequently in a certain text, i.e., the word which is considered to represent the substance (topic) of the text, has a large value of “idf”, while the words which occur uniformly in many texts, generally the particles and auxiliary verbs, each have a small value of “idf”.

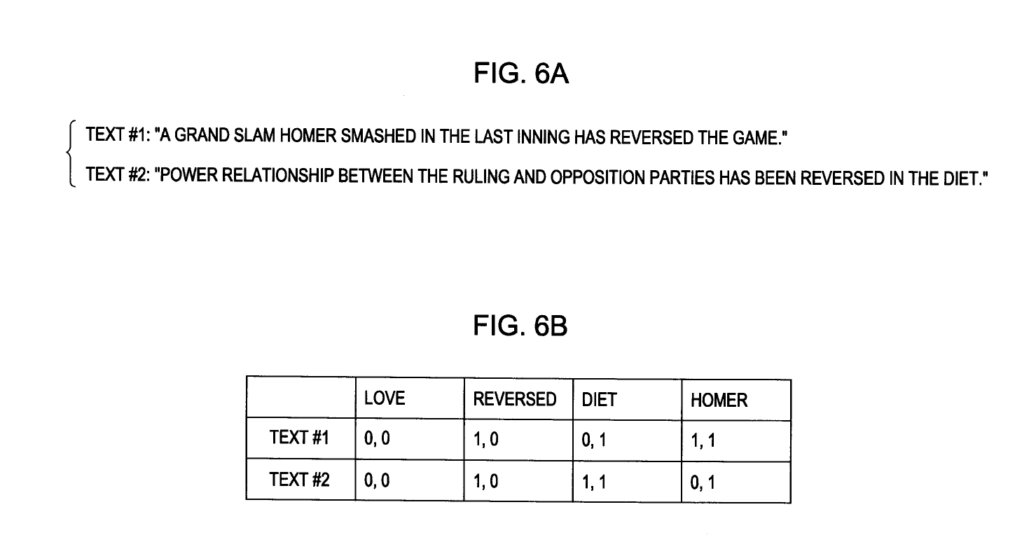

FIGS. 6A and 6B illustrate “tf” and “idf”.

It is noted that FIGS. 6A and 6B show excerpts from: Jin et al., “GENGO TO SHINRI NO TOUKEI; KOTOBA TO KOUDOU NO KAKURITSU MODERU NIYORU BUNSEKI”, published by Iwanami Shoten.

FIG. 6A shows a set of texts.

In FIG. 6A, for simplification of explanation, the text set includes of two texts of Text #1: “A grand slam homer smashed in the last inning has reversed the game.” and Text #2: “Power relationship between the ruling and opposition parties has been reversed in the Diet.”

FIG. 6B shows “tf” and “idf” for each of the words “love”, “reversed”, “Diet”, and “homer”, for the text set shown in FIG. 6A.

In FIG. 6B, “tf” and “idf” are separated by a comma so as to be shown in the form of “tf,idf”.

It is noted that “TF-IDF” as a combination of “tf” and “idf” is expressed, e.g., by the following expression (3).

W_{i,j}=tf_{i,j}/maxₖ{tf_{k,j}}×log₂(N/dfᵢ) (3)

In the expression (3), “W_{i,j}” represents “TF-IDF” of the word tᵢ in the text #j, “tf_{i,j}” represents the frequency of occurrence of the word tᵢ in the text #j, and “maxₖ{tf_{k,j}}” represents the frequency of occurrence of the word tₖ having the largest occurrence frequency among the words occurring in the text #j. Further, “N” represents the total number of texts (obtained by summing up the numbers of the example and input sentences), and “dfᵢ” represents the number of texts among the N texts which include the i-th word tᵢ.

[Description of Metadata Collecting Process]

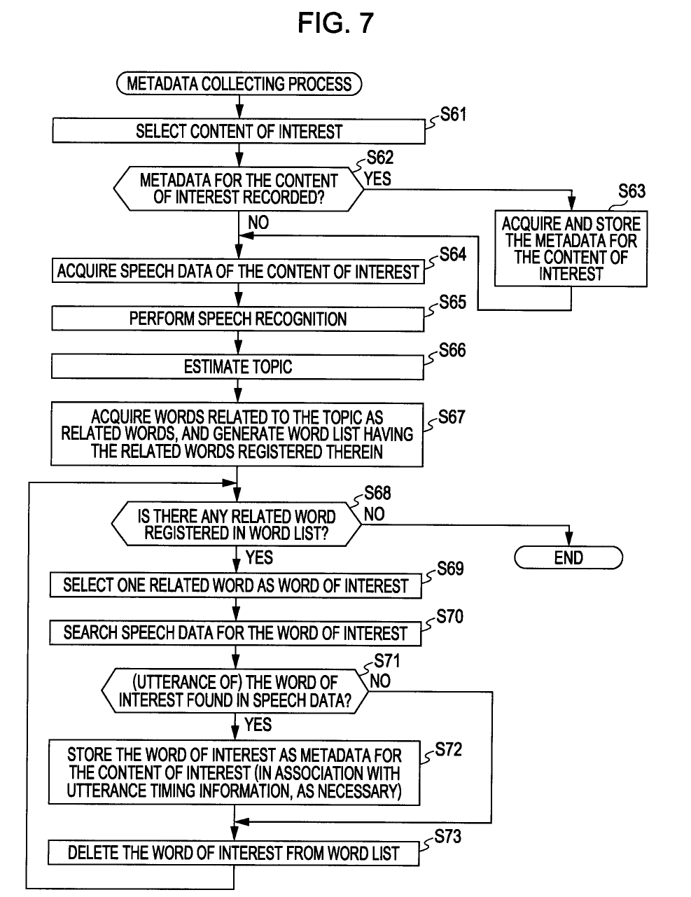

Referring to FIG. 7, the metadata collecting process carried out in the recorder shown in FIG. 4 will be described.

Steps S61 to S65 in the metadata collecting process shown in FIG. 7 are identical to steps S11 to S15, respectively, shown in FIG. 2.

When at least one word (string) is obtained as a result of speech recognition which is performed in step S65 by the speech recognition unit 22 on the speech data of the content of interest supplied from the speech data acquiring unit 21, the at least one word obtained through the speech recognition is supplied as the recognition result metadata to the metadata storing unit 26 for storage, and also supplied to the topic estimating unit 61.

Thereafter, the process proceeds from step S65 to step S66, where the topic estimating unit 61 estimates a topic of the sentence (example sentences) similar to the at least one word supplied as a result of the speech recognition from the speech recognition unit 22, as a topic of the content of interest. The topic estimating unit 61 then supplies the resultant topic to the related word acquiring unit 23, and the process proceeds to step S67.

Here, the topic estimating unit 61 may estimate a topic of broad category (category of broader concept) such as politics, economics, sports, or variety, or may estimate a topic of more detailed category.

In step S67, the related word acquiring unit 23 acquires any word related to the topic of the content of interest supplied from the topic estimating unit 61, as a related word.

Specifically, the related word acquiring unit 23 may store lists of words related to various topics as the topic related word lists, as described above, and acquire the words registered in the topic related word list corresponding to the topic of the content of interest supplied from the topic estimating unit 61, as the related words.

Here, the topic is estimated from at least one word obtained as a result of speech recognition, and accordingly, it can be said that the word related to the topic is the word related to the at least one word obtained through the speech recognition.

It is noted that the related word acquiring unit 23 may also acquire, as the related word, any word related to the words included in the pre-assigned metadata stored in the metadata storing unit 26, as in the case of the recorder shown in FIG. 1.

When the related word acquiring unit 23 acquires the related words, it generates a word list in which the related words are registered, and supplies the list to the speech retrieval unit 24. The process then proceeds from step S67 to step S68. Thereafter, steps S68 to S73, which are identical to respective steps S17 to S22 in FIG. 2, are performed.

It is noted that the recorder shown in FIG. 4 uses the metadata collected in the metadata collecting process shown in FIG. 7 to perform the reproduction process in which content is recommended and reproduced. The reproduction process is identical to that shown in FIG. 3, and thus, description thereof will not be repeated here.

According to the recorder shown in FIG. 4, the metadata for the content can be obtained efficiently and with ease, as in the case of the recorder shown in FIG. 1. Further, even the words that are not the target words for speech recognition, such as new words and proper names, can be obtained as the metadata.

[Description of Computer to which the Present Invention has been Applied]

The series of processes described above may be carried out by hardware or by software. In the case where the series of processes are to be carried out by software, the program constituting the software is installed into a general purpose computer or the like.

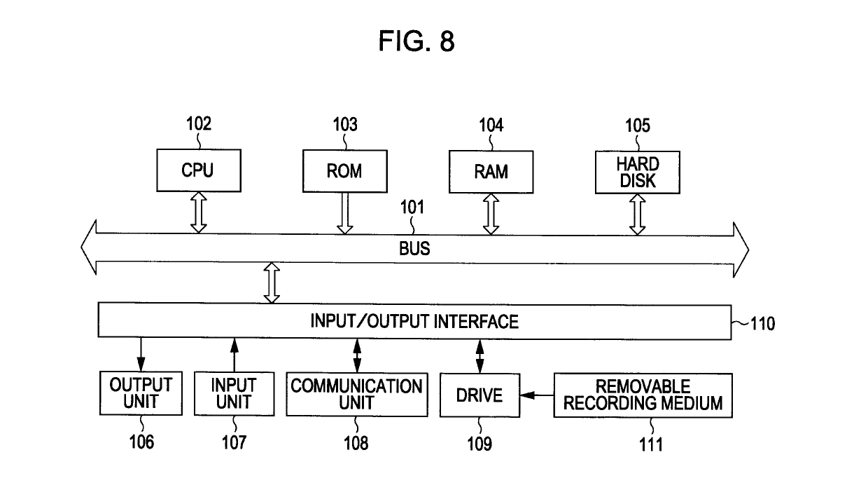

FIG. 8 shows a configuration example of an embodiment of the computer into which the program for executing the above-described processes is installed.

The program may be recorded in advance in a hard disk 105 or a read only memory (ROM) 103, which are recording media incorporated in the computer.

Alternatively, the program may be temporarily or permanently stored (recorded) in a removable recording medium 111, such as a flexible disk, a compact disc read only memory (CD-ROM), a magneto optical (MO) disc, a digital versatile disc (DVD), a magnetic disc, a semiconductor memory, or the like. The removable recording medium 111 may be provided as so-called package software.

While the program may be installed into the computer from the removable recording medium 111 as described above, the program may also be transferred from a download site to the computer in a wireless manner via an artificial satellite such as a digital broadcast satellite, or may be transferred to the computer in a wired manner via a network such as a local area network (LAN) or the Internet. The program transferred in any of the above-described manner may be received by a communication unit 108 in the computer, and installed into the hard disk 105 incorporated in the computer.

The computer includes a central processing unit (CPU) 102. The CPU 102 is connected to an input/output interface 110 via a bus 101. When a user operates an input unit 107, which is composed of a keyboard, mouse, microphone and others, to input an instruction via the input/output interface 110, the CPU 102 executes the program stored in the ROM 103 in accordance with the instruction. Alternatively, the CPU 102 may load the program from the hard disk 105 to a random access memory (RAM) 104 for execution, wherein the program may be the one stored in the hard disk 105, the one transferred from the satellite or the network and received by the communication unit 108 and installed into the hard disk 105, or the one read from the removable recording medium 111 mounted to a drive 109 and installed into the hard disk 105. In this manner, the CPU 102 performs the processes illustrated in the above-described flowcharts, or the processes performed by the configurations in the above-described block diagrams. The CPU 102 then outputs a result of the processes from an output unit 106, which is composed of a liquid crystal display (LCD), a speaker and others, via the input/output interface 110, or transmits it from the communication unit 108, or records it on the hard disk 105 or the like, as necessary.

It is noted that the process steps of coding the program for causing the computer to perform various processes do not necessarily have to be performed in the time sequence in accordance with the order illustrated as the flowchart. The processes may be performed in parallel (as in parallel processing) or may be performed individually (on an object basis).

Furthermore, the program may be processed by a single computer, or may be processed by a plurality of computers in a distributed manner. Furthermore, the program may be transferred to a remote computer for execution.

A specific example will now be described. The names of the candidates for President of the United States, “Barack Obama” and “John McCain”, have suddenly become frequently appearing in the content of television broadcast programs since 2008 when a presidential election took place in the United States.

In general, however, these names are not included in the word dictionary used for large vocabulary continuous speech recognition before, and it is thus necessary to update the word dictionary to enable speech recognition of those names.

As the word dictionary is updated repeatedly and the number of words included in the word dictionary increases, the words phonetically similar to each other increase, which may lead to degradation in precision of the speech recognition.

Meanwhile, in the recorder shown in FIG. 1 or 4, typical large vocabulary continuous speech recognition is once performed for analysis (speech recognition) of the speech data of the content, so as to acquire general words included in the speech data.

From the speech data of the content where the above-described names of the candidates for President of the United States appear, it is expected that the words such as “United States”, “president”, and “election” will be acquired as the general words by the speech recognition.

After the speech recognition, in the recorder shown in FIG. 1 or 4, any words related to the at least one word obtained through the speech recognition are acquired as the related words.

Specifically, in the recorder shown in FIG. 1, in the related word acquiring unit 23, the words which are likely to occur together with the words obtained as a result of the speech recognition are acquired as the related words.

The words which would likely occur together with the words obtained as a result of the speech recognition may be acquired by using the data of word co-occurrence probabilities as described above, or may be acquired in the following manner. A search engine on the Internet may be used to perform search using the word obtained through the speech recognition as a keyword. Then, in the web page obtained through the search, the word whose occurrence frequency is high may be selected as the word which would likely occur together with the word obtained through the speech recognition.

In the case of the recorder shown in FIG. 4, in the topic estimating unit 61, a topic of the content is estimated from at least one word obtained as a result of speech recognition, and in the related word acquiring unit 23, the words appearing in the sentences of that topic are acquired as the related words.

For estimation of a topic, a topic of broad classification such as “politics”, “economics”, “sports” or the like may be estimated, or a topic of detailed classification such as “politics—Japan”, “politics—U.S.”, “politics—China” or the like may be estimated.

In general, performance of prediction of the related word, acquired in the related word acquiring unit 23 at the succeeding stage of the topic estimating unit 61, may improve as a topic of more detailed classification is estimated. That is, the probability that the related word acquired by the related word acquiring unit 23 is included in an utterance in the speech data increases. This however leads to an increase in amount of learning data necessary in advance for creating a model for estimating a topic.

In the recorder shown in FIG. 4, as a way of acquiring the word related to the topic as the related word in the related word acquiring unit 23, the method using the topic related word list as described above may be replaced with a method using a news site on the Internet.

Specifically, for example assume that “United States”, “president”, and “election” have been acquired as at least one word obtained through the speech recognition, as described above, and that the topic of the content has been estimated as “politics—U.S.” from those words.

In this case, the related word acquiring unit 23 may access a news site on the Internet to check the words appearing in the articles related to the topic of “politics—U.S.”. Then, the related word acquiring unit 23 may consider any word appearing in the articles within a predetermined number of days from the present day as new words (or latest words), and acquire the new words as the related words.

For example, it is expected that in 2008 when the presidential election took place in the United States, the names of the candidates for President of the United States, “Barack Obama”, “John McCain”, and “Hillary Clinton”, are obtained as the new words for the topic of “politics—U.S.”

This ensures that the timely words such as “Barack Obama” can be obtained as the metadata, which could not have been acquired easily by only the general large vocabulary continuous speech recognition.

In this case, in the reproduction process (shown in FIG. 3), when a user operates the operation unit 41 to input a keyword “Barack Obama”, for example, recommendation and/or reproduction of the content having the speech data including an utterance of “Barack Obama” is performed.

Here, as the source of information for acquiring the new words as the related words, besides the information included in the server (site) on the Internet, EPG data which is transmitted via television broadcasting, data which is transmitted via data broadcasting, and closed caption for hearing-impaired persons may be used.

It should be noted that the recorders shown in FIGS. 1 and 4 are different from the technique disclosed in Japanese Unexamined Patent Application No. 2008-242059 mentioned above in the following point. In the recorders shown in FIGS. 1 and 4, the related words can be acquired from a server on the network such as the Internet. In contrast, in the above-described technique of the related art where a continuous speech recognition dictionary is generated from a corpus to be recognized, and a complementary recognition dictionary for improving recognition of unregistered words is also generated in consideration of the continuous speech recognition dictionary, and both the continuous speech recognition dictionary and the complementary recognition dictionary are used for continuous speech recognition, the corpus to be recognized is necessary.

Furthermore, the recorders shown in FIGS. 1 and 4 are different from the technique of the related art in that, while the recorders shown in FIGS. 1 and 4 acquire the related words by using probability of co-occurrence with a word obtained as a result of speech recognition or by using a topic estimated from the word, the technique of the related art generates the complementary recognition dictionary in consideration of the number of syllables included in a word as well as the part of speech of the word.

The present application contains subject matter related to that disclosed in Japanese Priority Patent Application JP 2008-332133 filed in the Japan Patent Office on Dec. 26, 2008, the entire content of which is hereby incorporated by reference.

It should be understood that the present invention is not restricted to the above-described embodiments, and that various modifications are possible within the scope not deviating from the gist of the present invention.

What is claimed is:

1. A data processing apparatus comprising:
speech recognition means for performing continuous speech recognition on speech data;
related word acquiring means for acquiring a word related to at least one word obtained through the continuous speech recognition, as a related word that is related to content corresponding to content data including the speech data; and
speech retrieval means for retrieving an utterance of the related word from the speech data so as to acquire the related word whose utterance has been retrieved as metadata for the content.

2. The data processing apparatus according to claim 1, further comprising topic estimating means for estimating a topic of substance of speech corresponding to the speech data, on the basis of a result of the continuous speech recognition, wherein
the related word acquiring means acquires a word related to the topic as the related word.

3. The data processing apparatus according to claim 2, wherein the related word acquiring means acquires, from among words related to the at least one word obtained through the continuous speech recognition, a word other than the words that should be recognized by the continuous speech recognition, as the related word.

4. The data processing apparatus according to claim 2, wherein the related word acquiring means acquires a new word appearing in a sentence of the topic, as the related word.

5. The data processing apparatus according to claim 2, wherein
the content data is assigned metadata for the content, and
the topic estimating means estimates the topic also on the basis of the metadata assigned to the content data.

6. The data processing apparatus according to claim 5, wherein
the content data is data of a program included in broadcast data in television broadcasting,
the broadcast data includes electronic program guide (EPG) data as the metadata for the program in addition to the data of the program, and
the topic estimating means estimates the topic also on the basis of the EPG data included in the broadcast data.

7. The data processing apparatus according to claim 5, wherein in the case where the metadata assigned to the content data includes a proper name, the related word acquiring means acquires, as the related word, also a proper name that is related to the proper name included in the metadata assigned to the content data.

8. The data processing apparatus according to claim 2, wherein the related word acquiring means acquires the related word from a server on a network.

9. The data processing apparatus according to claim 2, further comprising:
metadata storing means for storing the metadata for the content in association with the content data;
metadata retrieval means, when a keyword is input, for retrieving metadata matching or similar to the keyword from the metadata stored in the metadata storing means; and
content recommendation means for recommending content that corresponds to the content data associated with the metadata retrieved by the metadata retrieval means.

10. The data processing apparatus according to claim 9, further comprising reproduction control means, when content to be reproduced is designated from among the content recommended by the content recommendation means, for reproducing the designated content.

11. A data processing method comprising the steps of:
performing continuous speech recognition on speech data;
acquiring a word related to at least one word obtained through the continuous speech recognition as a related word that is related to content corresponding to content data including the speech data; and
retrieving an utterance of the related word from the speech data so as to acquire the related word whose utterance has been retrieved as metadata for the content;
the steps being performed by a data processing apparatus.

12. A program for causing a computer to function as:
speech recognition means for performing continuous speech recognition on speech data;
related word acquiring means for acquiring a word related to at least one word obtained through the continuous speech recognition as a related word that is related to content corresponding to content data including the speech data; and
speech retrieval means for retrieving an utterance of the related word from the speech data so as to acquire the related word whose utterance has been retrieved as metadata for the content.

13. A data processing apparatus comprising:
a speech recognition unit configured to perform continuous speech recognition on speech data;
a related word acquiring unit configured to acquire a word related to at least one word obtained through the continuous speech recognition as a related word that is related to content corresponding to content data including the speech data; and
a speech retrieval unit configured to retrieve an utterance of the related word from the speech data so as to acquire the related word whose utterance has been retrieved as metadata for the content.
